(19) United States
(12) Patent Application Publication
(10) Pub. No.: US 2006/0108341 A1
(43) Pub. Date: May 25, 2006

(54) Method and installation for pointing a fine fluid jet, in particular in welding, or laser hardfacing

(75) Inventors: Philippe Alips, Armbouts Cappel (FR); Francois Dubrulle, Dunkerque (FR); Gabriel Vergniez, Boisdinghem (FR)

Correspondence Address: SUGHRUE MION, PLLC, 2100 PENNSYLVANIA AVENUE, N.W., SUITE 800, WASHINGTON, DC, 20037, US

(73) Assignee: Usinor, Puteaux (FR)

(21) Appl. No.: 10/532,241

(22) PCT Filed: Oct. 22, 2003
(86) PCT No.: PCT/FR03/03131

§ 371 Date: Dec. 16, 2005

(30) Foreign Application Priority Data
Oct. 31, 2002 (FR) 02/13720

(51) Int. Cl. B23K 26/14

(52) U.S. Cl. 219/121.84

(57) ABSTRACT

The invention concerns a method for pointing a fine fluid jet onto a zone or an object in particular in welding, machining, or laser hardfacing, the jet being emitted from a blowing nozzle (5), the nozzle comprising an exhaust channel (10) including a terminal portion (11) of substantially circular cross-section having a diameter not greater than 5 mm, a light source (3) arranged in the axis of the discharge channel (10) upstream of the nozzle (5) in the flow direction of the fluid flux, generating a non-divergent mono- or polychromatic light beam whereof at least one wavelength ranges between 400 and 760 nanometers, coaxial with the exhaust channel (10) and propagated inside the channel in the flow direction of the fluid, whereby, the fluid flow being momentarily interrupted, by relative displacement of the object or zone or the light beam, the light beam is pointed on the object or the zone and the fine fluid jet is projected onto the zone or object.

The preferred technical field of the invention is that of welding, machining or surfacing with a laser beam.

In particular, laser welding has undergone considerable development in recent years in the area of assembly of bore or coated metal sheet for automobile applications. This process involves the use of gas jets in various ways:
nozzles that are coaxial or lateral with respect to the laser beam, allowing gas to be supplied at a rate of 15 to 30 l/min. The role of this gas is to shield the liquid metal and the solidified zone at high temperature, without there being disruption to the weld pool;
another role of the gas during laser welding is to expel the plasma (metal vapors and ionized gases) produced by the interaction between the beam and the material. This plasma, being opaque to the radiation, may absorb up to 70% of the energy of the beam and considerably reduce the penetration. By controlling the plasma it is therefore possible to weld at an increased rate and obtain an improved appearance of the bead after welding. In this case, the gas is supplied with a high flow rate via a nozzle of small diameter, of the order of a few millimeters. The nozzle is only attached to the head comprising the laser beam, but shifted longitudinally to the rear of the latter in the direction of welding. The nozzle is inclined so that the gas jet coincides with the beam interaction zone; and
furthermore, in the case of laser welding of coated steel sheet, the blowing of a fine gas jet via an offset nozzle acts favorably on the venting of the metal vapors within the molten liquid, and therefore on the reduction in porosity.

Experience has shown that it is necessary for the gas jet to be precisely positioned with respect to the interaction zone:
in butt welding, the intersection of the axis of the gas jet must be located at 0.5 mm above the surface of the sheet: too close to the latter, the gas jet will disturb the ejection of the metal vapors coming from the capillary (or “keyhole”). Far away, this gas jet no longer has a mechanical action on the flowing of the plasma. The plasma control regulation in laser welding is therefore a particularly tricky point;
in laser lap welding, it is possible to project the gas jet to the rear of the liquid pool so as to exert pressure on the latter and reduce the formation of porosity, but the precision in positioning this jet must be better than one millimeter.

Thus, these various examples illustrate the fact that the very precise positioning or pointing of the gas jet from the nozzle offset relative to the beam is a key element in obtaining laser welded joints of satisfactory quality.

At the present time, this pointing is carried out by the following means:
a metal wire is inserted, so as to be relatively stable, inside the nozzle, for the purpose of defining the gas jet and its point of impact relative to the beam;
the gas jet is also defined by fastening a very light element (a wire, etc.) to the outlet of the nozzle, said element being oriented in the presence of the gas jet; and
in butt welding, it has also been observed that the symmetry of the solidification waves on the bead gives an indication about the lateral positioning of the nozzle relative to the longitudinal axis of displacement of the laser beam.

However, all these methods have serious drawbacks: they are imprecise, not very reproducible, and depend greatly on the operator. These difficulties have also led many laser welding users to abandon the so advantageous method of controlling the plasma, mentioned above.

Although the points that have been explained relate to laser welding, other techniques using fine jets of fluids (liquids, gases, fluids possibly containing fine particles) also require precise pointing of the impact of the jet: for example, mention may be made of certain gas welding processes, machining processes (drilling, cutting) and surface treatments, especially surfacing.

The object of the present invention is to solve the abovementioned problems. In particular, its aim is to display, in a precise and reproducible manner, the impact of a fine fluid jet on a zone or an object during a welding, machining or surfacing operation, especially using a laser beam.

With these objectives in mind, the subject of the invention is a method of pointing a fine fluid jet onto a zone or an object, especially in laser welding, machining or surfacing, this jet being emitted from a blowing nozzle, the nozzle having an ejection channel comprising a terminal portion of substantially circular cross section having a diameter not exceeding 5 mm, a light source placed on the axis of the ejection channel upstream of the nozzle in the direction of flow of the flux of the fluid, generating a monochromatic or polychromatic nondivergent light beam, at least one wavelength of which is between 400 and 760 nanometers, coaxial with the ejection channel and propagating inside the channel in the flow direction of the fluid, in which, with the flow of the fluid being temporarily interrupted, by relative displacement of the object or the zone or the light beam, the light beam is pointed onto the object or the zone and the fine fluid jet is sent onto the zone or the object.

According to one feature of the invention, the fluid is a gas.

According to another feature, the fluid contains fine particles.

The subject of the invention is also a device for implementing the method as claimed in the invention, comprising a nozzle for blowing a fluid, the nozzle having an ejection channel comprising a terminal portion of substantially circular cross section having a diameter not exceeding 5 mm, a laser light source placed on the axis of the ejection channel upstream of the nozzle in the direction of flow of the flux of the fluid, generating a monochromatic nondivergent light beam, at least one wavelength of which is between 400 and 760 nanometers, coaxial with the ejection channel and propagating inside the channel in the flow direction of said fluid, and means for supplying the nozzle with fluid.

The device according to the invention may advantageously have one or more of the following features, by themselves or in combination:
the light source is isolated from the fluid jet by an impermeable separator;
the length of the terminal portion of the fluid ejection channel is greater than or equal to five times the diameter of the terminal portion of the ejection channel;
the device includes an alignment means for ensuring coaxiality of the fluid jet and of the light flux.

The subject of the invention is also a welding, machining or surfacing installation comprising at least one pointing device according to the invention.

Preferably, the welding, machining or surfacing head of this welding, machining or surfacing installation is firmly connected to a cradle on which at least one device as claimed in the invention is mounted, the cradle being able to be oriented, rotationally or translationally, so as to precisely point the fluid jet.

According to a preferred feature of the invention, the welding, machining or surfacing is carried out by a laser beam.

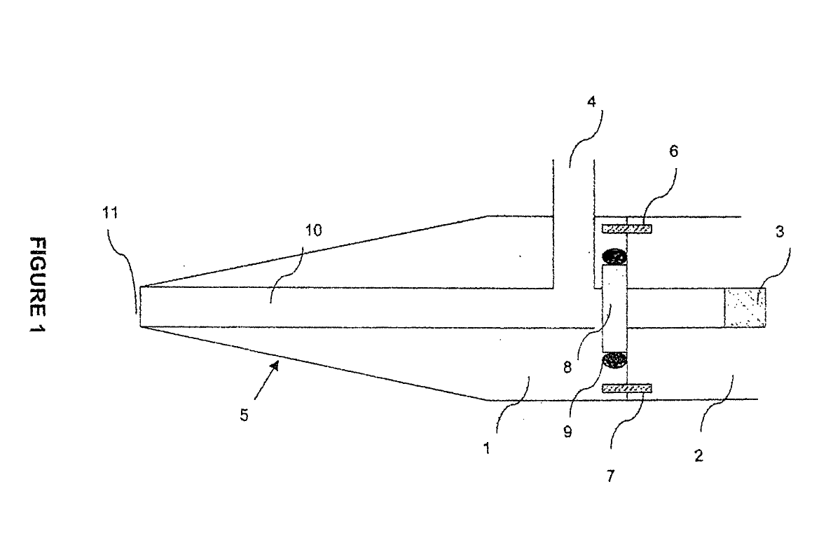

The invention will now be described more precisely, but not limitingly, in conjunction with the appended FIG. 1, which shows schematically a blowing nozzle provided with a device according to the invention. The device comprises two portions:
an assembly 1, which includes the inlet for the fluid flux;
an assembly 2, which includes a light source 3.

The radiation emitted by the source, and intended to be visible to an operator, at least partly lies within the spectral range from 400 to 760 nm. To obtain precise pointing onto objects located at various distances, the light beam is nondivergent, the beam being obtained for example by means of a suitable lens known per se.

It is advantageous to use, as light source, a diode laser so as to obtain a very point-like beam with good visibility over a large depth of field.

The fluid enters the assembly 1 via the duct 4. This fluid may be a gas or liquid, or composed of several phases, such as for example fine solid particles suspended in a fluid. An ejection channel 10 then orients the fluid jet. The diameter of the substantially circular terminal portion 11 of the ejection channel does not exceed 5 millimeters in order to obtain greater pointing accuracy. The length of the terminal portion of the ejection channel, that is to say the length of the portion where the flow of fluid is coaxial with the light beam, and in the same direction as the latter, is preferably greater than 5 times its diameter so as to ensure stability of the fluid jet, while minimizing any turbulence.

The assemblies 1 and 2 are firmly attached to each other by a suitable mechanical means known per se. An isostatic adjustment means ensures perfect coaxiality of the gas and light beams. For this purpose, the device may include, as indicated in FIG. 1, studs 6 and 7 so as to ensure that the assemblies 1 and 2 are coaxially aligned, perfectly and reproducibly.

If it is desired to ensure that the source 3 is sealed from the fluid, an impermeable separator 8 is put into position, this being optically transparent to the light flux emanating from the source. This separator rests on a seat machined in the assembly 1 or the assembly 2. An O-ring seal 9, for example, provides the sealing.

When the device described is used for pointing a fluid beam, especially a gas beam, during a welding, machining or surfacing operation, the entire pointing device described above is advantageously mounted on a cradle (known per se, but not shown in FIG. 1) firmly connected to the welding, machining or surfacing head. This cradle can be oriented, translationally and rotationally, so that the orientation of the light beam and of the gas flux is easily and precisely adjusted.

Firstly, the light beam emanating from the source is oriented approximately in the direction of the target zone or object of the fluid jet, the flow of the fluid being interrupted at this moment. By means of finer adjustments for the translational or rotational movement of the support cradle for the pointing installation, or for the displacement of the target object, the light beam is pointed very accurately on the target zone or object. The ejection of the fluid is then triggered, the fine jet of which is thus precisely targeted on the zone or object.

The invention has a number of advantages: by predisplaying the impact of a very fine fluid jet, the pointing method and the pointing installation avoid using jets with a high flow rate of sometimes expensive gases, the impact of which may disturb certain processes. Integrating the light source within the actual fluid nozzle ensures high pointing accuracy and, in the case of welding, the shielding of this same source in the event of contamination by metal vapors. Thanks to this pointing accuracy, it is possible to substantially reduce the defects and to increase the efficiency of welding, machining or surfacing installations.

1. A method of pointing a fine fluid jet onto a zone or an object, especially in laser welding, machining or surfacing, said jet being emitted from a blowing nozzle (5), said nozzle having an ejection channel (10) comprising a terminal portion (11) of substantially circular cross section having a diameter not exceeding 5 mm, a light source (3) placed on the axis of the ejection channel (10) upstream of said nozzle (5) in the direction of flow of the flux of said fluid, generating a monochromatic or polychromatic nondivergent light beam, at least one wavelength of which is between 400 and 760 nanometers, coaxial with the ejection channel (10) and propagating inside said channel in the flow direction of said fluid, in which, with the flow of said fluid being temporarily interrupted, by relative displacement of said object or said zone or said light beam, said light beam is pointed onto said object or said zone and said fine fluid jet is sent onto said zone or said object.

2. The method as claimed in claim 1, characterized in that the fluid is a gas.

3. The method as claimed in either of claims 1 and 2, characterized in that the fluid contains fine particles.

4. A device for implementing the method as claimed in any one of claims 1 to 3, characterized in that it comprises a nozzle (5) for blowing a fluid, said nozzle having an ejection channel (10) comprising a terminal portion (11) of substantially circular cross section having a diameter not exceeding 5 mm, a laser light source (3) placed on the axis of the ejection channel (10) upstream of said nozzle (5) in the direction of flow of the flux of said fluid, generating a monochromatic nondivergent light beam, at least one wavelength of which is between 400 and 760 nanometers, coaxial with the ejection channel (10) and propagating inside said channel in the flow direction of said fluid, and
means for supplying said nozzle with fluid.

5. The device as claimed in claim 4, characterized in that the light source (3) is isolated from said fluid jet by an impermeable separator (8).

6. The device as claimed in either of claims 4 and 5, characterized in that the length of the terminal portion of the fluid ejection channel (10) is greater than or equal to five times the diameter of the terminal portion (11) of the ejection channel (10).

7. The device as claimed in any one of claims 4 to 6, characterized in that it includes an alignment means (6) for ensuring coaxiality of said fluid jet and of said light flux.

8. A welding, machining or surfacing installation, characterized in that it comprises at least one device as claimed in any one of claims 4 to 7.

9. A welding, machining or surfacing installation, characterized in that the welding, machining or surfacing head is firmly connected to a cradle on which at least one device as claimed in any one of claims 4 to 7 is mounted, said cradle being able to be oriented, rotationally or translationally, so as to precisely point said fluid jet.

10. The installation as claimed in claim 8 or 9, characterized in that the welding, machining or surfacing is carried out by a laser beam.
